(19) United States
(12) Patent Application Publication
(10) Pub. No.: US 2023/0252426 A1
(43) Pub. Date: Aug. 10, 2023

(54) SYSTEM AND METHOD FOR STAFFING AUTOMATION

(71) Applicant: Gig Forces, Inc. DBA onDiem, Portland, OR (US)

(72) Inventor: Joe Fogg, Portland, OR (US)

(21) Appl. No.: 18/165,242

(22) Filed: Feb. 6, 2023

Related U.S. Application Data
(60) Provisional application No. 63/307,609, filed on Feb. 7, 2022.

(51) Int. Cl. G06Q 10/1093

(52) U.S. Cl. CPC G06Q 10/1097

(57) ABSTRACT

Systems and methods are provided for staffing automation, including a database of workers and time slots including available time slots. An application programming interface (API) is executed to receive a user request from practice management software (PMS) of a client device to determine one or more workers to staff a target time slot, send a staff list of the one or more workers to the PMS of the client device, and receive a user selection of one or more candidates among the one or more workers from the PMS of the client device. A scheduling program is executed to determine the one or more workers to staff the target time slot, and generate the staff list of the one or more workers to send to the PMS of the client device.

### CROSS REFERENCE TO RELATED APPLICATIONS

This application claims priority to U.S. Provisional Patent Application Ser. No. 63/307,609, filed Feb. 7, 2022 and titled AUTOMATED STAFFING PLATFORM, the entirety of which is hereby incorporated herein by reference for all purposes.

### BACKGROUND

Many businesses schedule clients based on an availability of a provider and/or an assistant, particularly in businesses in which the provider and/or assistant is assigned to a single provider station. When the availability of the provider and/or assistant outweighs the clientele demand for appointments, the business may reduce its workforce such that one or more stations remains vacant. However, when a business loses a provider and/or an assistant, or is forced to close for a period of time, the demand for appointments may outnumber the availability of the provider and/or assistant. Therefore, a challenge exists in matching clientele demand for appointments with available labor to maximize a capacity of the business without over- or under-staffing.

### SUMMARY

To address the issues discussed herein, a computing system for staffing automation is provided. The computing system comprises a processor and memory of a computing device. The memory stores a database comprising a plurality of workers and a plurality of time slots including a plurality of available time slots. The processor is configured to execute an application programming interface (API) using portions of the memory to receive a user request from practice management software of a client computing device to determine one or more workers of the plurality of workers to staff a target time slot among the plurality of available time slots, send a staff list of the one or more workers to the practice management software of the client computing device, and receive a user selection of one or more candidates among the one or more workers from the practice management software of the client computing device. The processor is further configured to execute a scheduling program using portions of the memory to determine the one or more workers of the plurality of workers to staff the target time slot among the plurality of available time slots, and generate the staff list of the one or more workers to send to the practice management software of the client computing device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a computing system for staffing automation according to an example of the present disclosure.

FIG. 2 is a detailed schematic view of the worker data and shift data of FIG. 1 according to an example of the present disclosure.

FIG. 3 illustrates a calendar view of the computing system of FIG. 1 according to an example of the present disclosure.

FIG. 4 illustrates a shift worker suggestion to fill a potential shift of the computing system of FIG. 1 according to the example of FIG. 3.

FIG. 5 illustrates a shift worker profile of the computing system of FIG. 1 according to the example of FIG. 3.

FIG. 6 is a flowchart of a computerized method for staffing automation according to an example embodiment of the present disclosure.

FIG. 7 shows an example computing environment of the present disclosure.

### DETAILED DESCRIPTION

Many businesses operate on a system in which the provider and/or assistant is assigned to a single provider station, and appointments are scheduled according to the availability of the provider and/or assistant. Some examples of such businesses are dental practices, medical practices, spas and salons, automobile mechanics, oil change stations, and the like. When the business is understaffed, one or more stations may be vacant. When the demand for appointments is greater than the capacity of the business, clients may look to alternative businesses to meet their needs. This situation can lead to lost income for the business, as well as paying overhead on unused space.

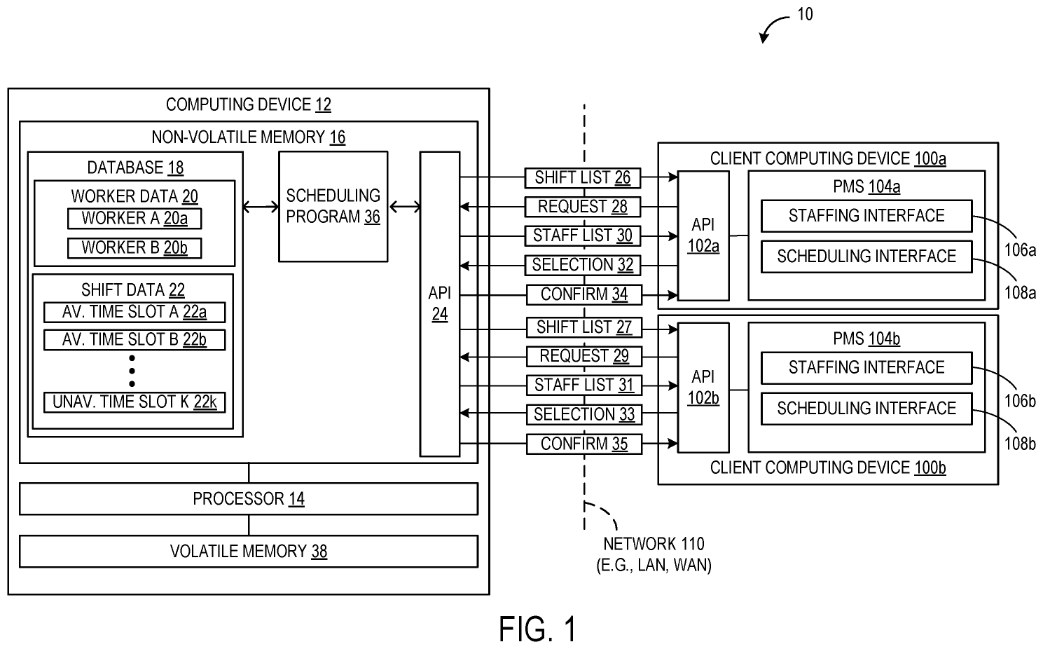

To address the issues discussed above, as shown in FIG. 1, a computing system 10 for staffing automation is provided. The computing system 10 comprises a processor 14 and memory 16 of a computing device 12. The memory 16 stores a database 18 comprising worker data 20 including a plurality of workers 20a, 20b and shift data 22 including a plurality of time slots 22a-k including a plurality of available time slots 22a, 22b. The processor 14 is configured to execute an application programming interface (API) 24 using portions of the memory 16 to receive a user request 28, 29 from practice management software 104a, 104b of a client computing device 100a, 100b to determine one or more workers of the plurality of workers 20a, 20b to staff a target time slot 22a among the plurality of available time slots 22a, 22b, send a staff list 30, 31 of the one or more workers to the practice management software 104a, 104b of the client computing device 100a, 100b, and receive a user selection 32, 33 of one or more candidates among the one or more workers 20a, 20b from the practice management software 104a, 104b of the client computing device 100a, 100b. The processor 14 is further configured to execute a scheduling program 36 using portions of the memory 16 to determine the one or more workers of the plurality of workers 20a, 20b to staff the target time slot 22a among the plurality of available time slots 22a, 22b, generate the staff list 30, 31 of the one or more workers to send to the practice management software 104a, 104b of the client computing device 100a, 100b, and assign the one or more candidates to the target time slot 22a.

The API 24 may send shift lists 26, 27 of available time slots 22a, 22b to the client computing devices 100a, 100b, respectively. The API 24 may also send confirmations 34, 35 to the client computing devices 100a, 100b, respectively, confirming that target time slot 22a has been staffed with the one or more candidates specified in the respective user selections 32, 33. The types of the practice management software 104a, 104b of the client computing devices 100a, 100b may be identified, and the shift lists 26, staff lists 30, 31, and the confirmations 34, 35 may then be formatted in accordance with respective formatting requirements of the types of the practice management software 104a, 104b of the respective client computing devices 100a, 100b, so as to be readable by the practice management software 104a, 104b, of the respective client computing devices 100a, 100b.

Although the API 24 and the scheduling program 36 are depicted as being hosted at one computing device 12, it will be appreciated that the API 24 and the scheduling program 36 may alternatively be hosted across a plurality of computing devices to which the computing device 12 is communicatively coupled via a network 110, including a client computing devices 100a, 100b operatively coupled to the computing device 12. In some examples, the network 110 may take the form of a local area network (LAN), wide area network (WAN), wired network, wireless network, personal area network, or a combination thereof, and can include the Internet.

The computing device 12 comprises the processor 14 configured to store the API 24 and the scheduling program 36 in non-volatile memory 16 that retains instructions stored data even in the absence of externally applied power, such as FLASH memory, a hard disk, read only memory (ROM), electrically erasable programmable memory (EEPROM), etc. The instructions include one or more programs, including the API 24 and the scheduling program 36, and data used by such programs sufficient to perform the operations described herein. In response to execution by the processor 14, the instructions cause the processor 14 to execute the API 24 and the scheduling program 36.

The processor 14 is a microprocessor that includes one or more of a central processing unit (CPU), a graphical processing unit (GPU), an application specific integrated circuit (ASIC), a system on chip (SOC), a field-programmable gate array (FPGA), a logic circuit, or other suitable type of microprocessor configured to perform the functions recited herein. The computing device 12 further includes volatile memory 38 such as random access memory (RAM), static random access memory (SRAM), dynamic random access memory (DRAM), etc., which temporarily stores data only for so long as power is applied during execution of programs.

The computing system 10 may be configured as an automated staffing platform which is compatible with different types of practice management software 104a, 104b executed on different client computing devices 100a, 100b. The workers 20a, 20b may be a plurality of employees at a company which is registered with the automated staffing platform. The client computing devices 100a, 100b may be business devices operated by users of third-party businesses, for example. The server-side API 24 is configured to interface with the client-side API 102a, 102b of the client computing devices 100a, 100b, respectively, to manage communication between the computing device 12 and the client computing devices 100a, 100b via the network 110. The server-side API 24 and the client-side API 102a, 102b may be configured as automated scheduling bots. The database 18 may include a plurality of workers 20a, 20b and a plurality of time slots 22a-b from a plurality of businesses registered with the automated staffing platform. It will be appreciated that the number of client computing devices 100a, 100b in the computing system 10 is not particularly limited, and may be more than two client computing devices executing different types of practice management software. For example, among client computing devices operated by dental practices, the different types of practice management software may include RevenueWell, Curve Dental, Pearl, CareStack, ABELDent, and others.

In one example the processor 14 receives a user request 28 from a client computing device 100a to fulfill a target available shift 22a, and determine, from the plurality of employees 20a, 20b, one or more candidate employees for the target available shift 22a. The processor 14 then sends, to the API 102a of the client computing device 100a, a staff list 30 including the candidate employees that are available for the target available shift 22a. The server-side API 24 is configured to communicate the staff list 30 of candidate employees with practice management software 104a installed on the client computing device 100a, and a user selects a candidate employee from the staff list 30 of candidate employees to fulfill the target available shift 22a. The user selection 32 of the candidate employee is sent to the computing device 12, and the candidate employee is assigned to the target available shift 22a. Additionally or alternatively, the processor 12 may automatically assign the candidate employee to the target available shift 22a without receiving a user selection of the candidate employee.

The client computing devices 100a, 100b execute practice management software 104a, 104b, comprising staffing interfaces 106a, 106b and scheduling interfaces 108a, 108b, respectively. In one example, the user of the client computing devices 100a, 100b is a scheduler or an office manager who typically uses the practice management software 104a, 104b to schedule clients at time slots at provider stations according to available providers and/or assistants. When one or more of provider stations is vacant, the API 24 may suggest one or more of the shift workers 20a, 20b registered with the automated staffing platform 10 to work at a vacant provider station such that clients may be scheduled on dates when schedules for the other provider stations are full. Additionally or alternatively, the API 24 may be executed as a robotic automated script (for example, a bot) which is programmed to assign available shift workers to vacant provider stations when an availability of providers reaches a predetermined limit. For example, when there are no available appointments for four weeks, the API 24 may start assigning available shift workers to vacant provider stations. The API 24 may also assign available shift workers when the scheduler makes an appointment for a vacant provider station, or when a client attempts to schedule an appointment online on a day when the providers and/or assistants are fully booked but a vacant provider station is available. A user or business may set predetermined filtering criteria and predetermining ranking criteria to filter and rank available shift workers to be assigned a shift, such as by length of experience, completed number of shifts, reviews, and the like, as described further below.

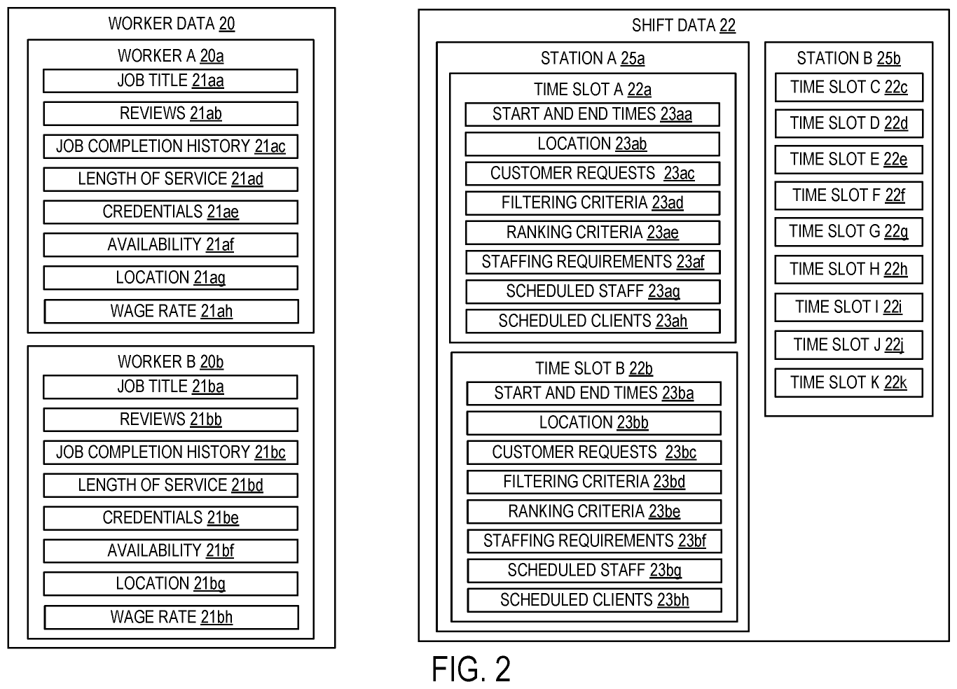

Turning to FIG. 2, the worker data 20 and shift data 22 illustrated in FIG. 1 are schematically depicted in further detail according to one example. The worker data 20 includes properties for each worker. In the example of FIG. 2, the worker data 20 includes data about the job title 21aa, reviews 21ab, job completion history 21ac, length of service 21ad, credentials 21ae, availability 21af, location 21ag, and wage rate 21ah of worker A 20a. The worker data 20 also includes data about the job title 21ba, reviews 21bb, job completion history 21bc, length of service 21bd, credentials 21be, availability 21bf, location 21bg, and wage rate 21bh of worker B 20b. The shift data 22 includes data about the time slots in each provider station 25a, 25b. In this example, time slot A 22a and time slot B 22b are scheduled for provider station A 25a, and time slots C through K 22c-k are scheduled for provider station B 25b. Time slot A 22a has properties including start and end times 23aa, location 23ab of the work shift, the number of customer requests 23ac for time slot A 22a (indicating a client demand level for time slot A 22a), predetermined filtering criteria 23ad, predetermined ranking criteria 23ae, staffing requirements 23af, scheduled staff 23ag who are already assigned to time slot A 22a, and scheduled clients 23ab who are already booked for time slot A 22a. Likewise, time slot B 22b has properties including start and end times 23ba, location 23bb of the work shift, the number of customer requests 23bc for time slot B 22b (indicating a client demand level for time slot B 22b), predetermined filtering criteria 23bd, predetermined ranking criteria 23be, staffing requirements 23bf, scheduled staff 23bg who are already assigned to time slot B 22b, and scheduled clients 23bb who are already booked for time slot B 22b.

Referring to FIGS. 1 and 2, the scheduling program 36 may be executed to determine a target unstaffed provider station 25a among a plurality of provider stations 25a, 25b, determine the plurality of available time slots 22a, 22b at the target unstaffed provider station 25a, and generate a shift list 26 of the plurality of available time slots 22a, 22b. The availability of time slot A 22a may be determined by comparing the scheduled staff 23ag to the staffing requirements 23af, and determining that the staffing requirements 23af have not been met. For example, if the staffing requirements 23af call for one dentist and one dental hygienist, and only one dentist is scheduled as the scheduled staff 23ag, then the processor 14 determines that time slot A 22a is available. The shift list 26 may be formatted in accordance with the practice management software 104a of the client computing device 100a in a format that is readable by the practice management software 104a, after identifying the type of the practice management software 104a of the client computing device 100a. The processor 14 may execute the scheduling program 36 to format the shift list 26 in different formats of different practice management software, depending on the type of the practice management software which is executed by the client computing device 100a. The API 24 may be executed to send the shift list 26 of the plurality of available time slots 22a, 22b to the practice management software 104a of the client computing device 100a before receiving the user request 28. Accordingly, the user may select from the most up-to-date shift list 26 of available time slots 22a, 22b. The shift list 26 may be sent via a protocol in accordance with the practice management software 104a of the client computing device 100a.

The target unstaffed provider station 25a may be determined based on predetermined criteria. For example, the predetermined criteria may comprise at least one of a proportion of vacant appointment time slots at the plurality of provider stations, or a number of customer requests for the target unstaffed provider station. Accordingly, the API 24 may suggest for the one or more workers 20a, 20b to work at the target unstaffed provider station 25a when schedules for the other provider station 25b are full, or when there are no available appointments at the other provider station 25b for four weeks, for example.

Additionally or alternatively, the target unstaffed provider station 25a may be determined based on the user request 28, which may include a request to staff a target unstaffed provider station 25a on a specified day. In this case, the scheduling program 36 is executed to determine the plurality of available time slots 22a, 22b at the target unstaffed provider station 25a requested by the user request 28, and generate a shift list 26 of the plurality of available time slots 22a, 22b.

After the API 24 receives the user request 28 from the client computing device 100a, the scheduling program 36 is executed to determine one or more workers of the plurality of workers 20a, 20b to staff a target time slot 22a among the plurality of available time slots 22a, 22b, and generate the staff list 30 of the one or more workers to send to the practice management software 104a of the client computing device 100a. To generate the staff list 30 for the target time slot 22a, the staff list 30 may be filtered based on predetermined filtering criteria 23ad corresponding to the target time slot 22a. For example, predetermined filtering criteria 23ad may comprise at least one of fulfilling a job title requirement (for example, a dental hygienist is required), fulfilling a credential requirement (for example, a dental hygienist credential is required), exceeding a predetermined review score threshold (for example, an average review of 4 out of 5 is required), completion of a predetermined threshold number of shifts (for example, a record of a minimum of 25 completed shifts is required), or experience exceeding a predetermined length (for example, at least seven years of relevant experience are required). The predetermined filtering criteria 23ad may be predefined by a user, or programmatically generated via an algorithm.

Further, the staff list 30 for the target time slot 22a may be ranked according to predetermined ranking criteria 23ae corresponding to the target time slot 22a. For example, the predetermined ranking criteria 23ae may comprise at least one of matching a location of the target time slot 22a with locations of the one or more workers, matching an availability of start and end times of the target time slot with availabilities of the one or more workers, or matching job title and credential requirements of the target time slot with job titles and credentials of the one or more workers. Accordingly, workers who live closer to the site of the target time slot 22a, workers who are actually available to work the target time slot 22a, and workers who meet the staffing requirements 23af of the target time slot 22a are given precedence in the staff list 30. The predetermined ranking criteria 23ae may be predefined by a user, or programmatically generated via an algorithm.

Features of the automated staffing platform 10 allow a business to fulfill available shifts with employees, thereby satisfying the needs of their clientele and increasing the profitability of the business. A detailed description of the automated staffing platform 10 follows according to an example of a dental practice. While the automated staffing platform 10 is described herein using the example of the dental practice, it will be appreciated that the automated staffing platform 10 may be implemented by any suitable business.

Dental practices have multiple dental chairs referred to as operatory, or operatory chairs, often labeled as Operatory 1, Operatory 2, and so on. Dental hygienists and dentists are typically assigned to treat the patients assigned to a specific Operatory. For example, Hygienist 1 may be assigned to Operatory 1, and treat the patients during that day who are scheduled in Operatory 1, while Hygienist 2 may be assigned to Operatory 2 and treat the patients during the day who are scheduled in Operatory 2. The operatories are examples of provider stations.

Dental practices often use specific dental practice management systems 104a, 104b to run their operations. These dental practice management systems 104a, 104b are either downloaded to the business device or are cloud-based software systems. One of the standard features of a dental practice management system 104a, 104b is the patient scheduling interface 108a, 108b. As described above, a scheduler or office manager of the practice will schedule patients in the dental practice management system 104a, 104b, which consists of looking for available appointments within the individual operatories.

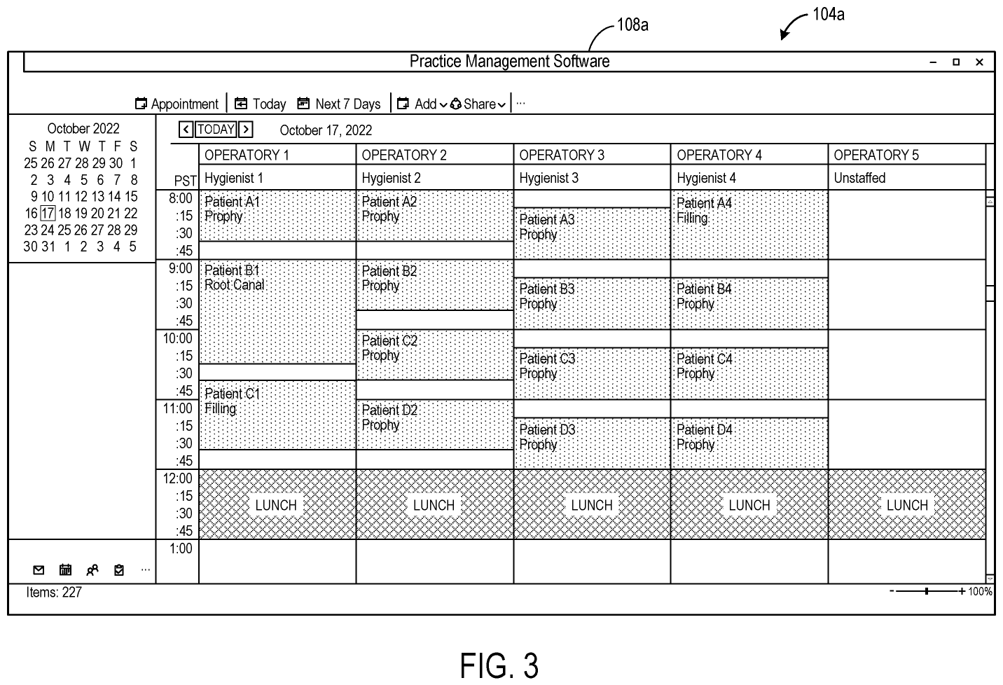

FIG. 3 illustrates an example calendar view of the patient scheduling interface 108a of a dental practice management system 104a, showing the appointments scheduled for the morning of one day. The operatories are listed in columns, and with each patient appointment for a same operatory appearing in the column. In the example of FIG. 3, four of the operatories are staffed, and a fifth operatory, Operatory 5, remains vacant.

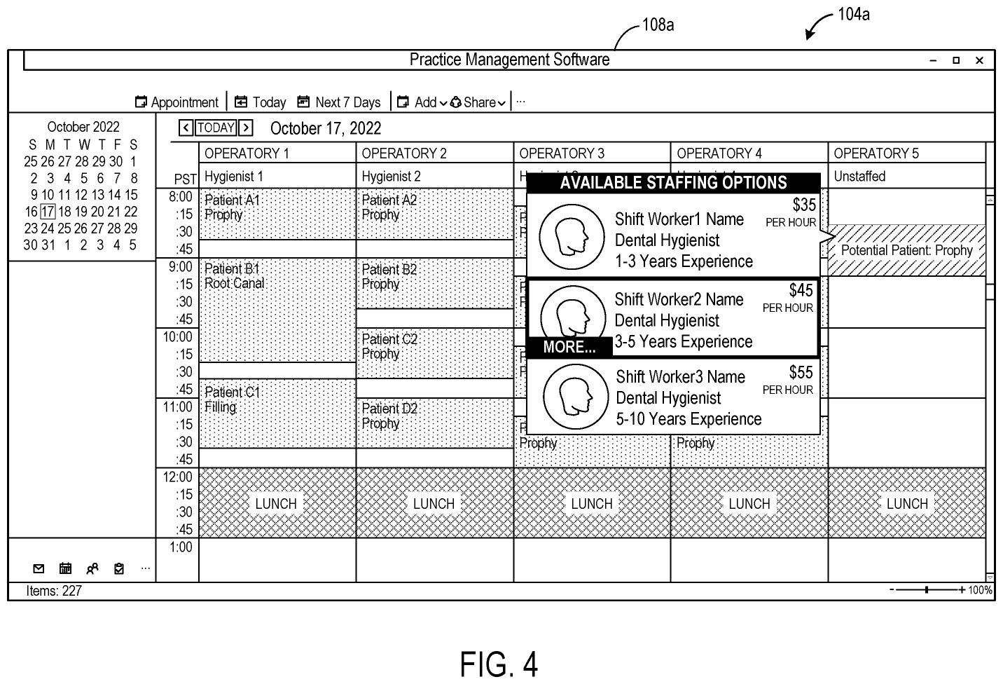

FIG. 4 illustrates the example calendar view of FIG. 3, with a modal (i.e., pop-up window element tied to an underlying GUI element) for a suggested shift worker to assign to Operatory 5 such that a potential appointment can be scheduled. In this example, the software of the automated staffing platform is integrated to the dental practice management system 104a via the API. The modal may appear in response to a query from the dental practice management system after scheduler schedules the appointment. Additionally or alternatively, the automated staffing platform may be configured to present modals for available shift workers as the scheduler is scheduling an appointment. When the scheduler selects an appointment time in Operatory 5, which is determined to be unstaffed on the day in question, a user selection of the appointment time (target time slot) in Operatory 5 (target unstaffed provider station) is sent to the API of the computing device. In response, the computing device generates and sends a staff list of one or more workers to staff the target time slot. The staff list is displayed as a modal for one or more available shift workers, appearing over the proposed appointment time, thereby allowing the scheduler to know that a provider and/or assistant is able to work in Operatory 5 at the proposed appointment time. The list of available shift workers may be filtered according to predetermined filtering criteria, and ranked according to predetermined ranking criteria. In this example, the predetermined ranking criteria cause the staff list to be ranked so that workers with lower wage rates are preferentially ranked.

Alternatively, the system may determine the requirements of the appointments that are being scheduled and the Operatory that is being staffed in real time dynamically and filter and rank the shift workers according to predetermined filtering criteria and predetermined ranking criteria, respectively. For example, the staff list of shift workers may be ranked according to those who have worked at the dental practice in the past, such that workers potentially familiar to the scheduler appear first in the list. The scheduler may then manually select the shift worker in the user selection, and the computing device may then assign the shift worker to the target time slot in Operatory 5.

The software of the automated staffing platform may also be integrated to the dental practice management system via an API, which in this example is configured as a scheduling bot. As described above, some practices may have an online scheduling portal that allows patients to schedule in Operatory 5. Upon reaching a predetermined number of appointments for a day in other Operatories, the bot may automatically select and schedule an available shift worker who meets the parameters to work in Operatory 5 for the day. The bot may choose from among a plurality of available shift workers according to predetermined ranking criteria specified by the dental practitioner, such as preferring shift workers who have worked in the same dental practice in the past, or shift workers with high reviews, a certain number of years of experience, or a certain hourly rate, as some examples. In one particular example, the dental practitioner may green light the bot to auto-schedule any shift worker who has worked at the dental practice in the past and received satisfactory performance reviews from the dental practice (i.e., who has been indicated as “available for re-hire”).

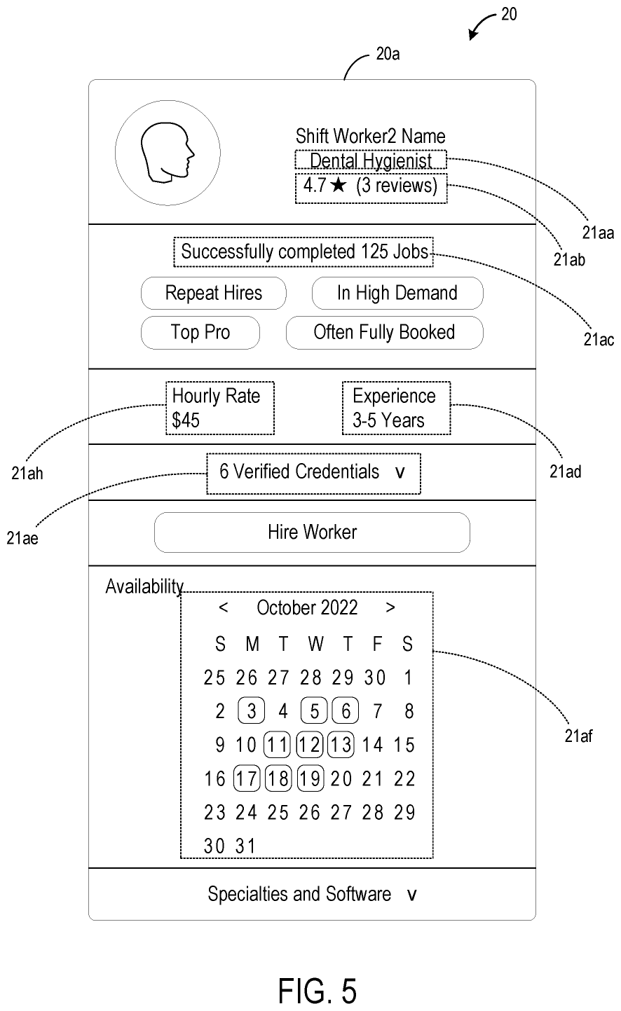

FIG. 5 shows an example of a shift worker profile, including work data 20 for worker A 20a. The profile may be viewed by selecting the respective modal of the shift worker, as shown at “MORE . . . ” in FIG. 4. In the example of FIG. 5, the worker data 20 includes data about the job title 21aa (dental hygienist), reviews 21ab (three reviews with 4.7 average stars), job completion history 21ac (successfully completed 125 jobs), length of service 21ad (3-5 years of experience), credentials 21ae (six verified credentials), availability 21af (available on October 3, 5, 6, 11-13, and 17-19), and wage rate 21ah ($45 hourly rate) of worker A 20a.

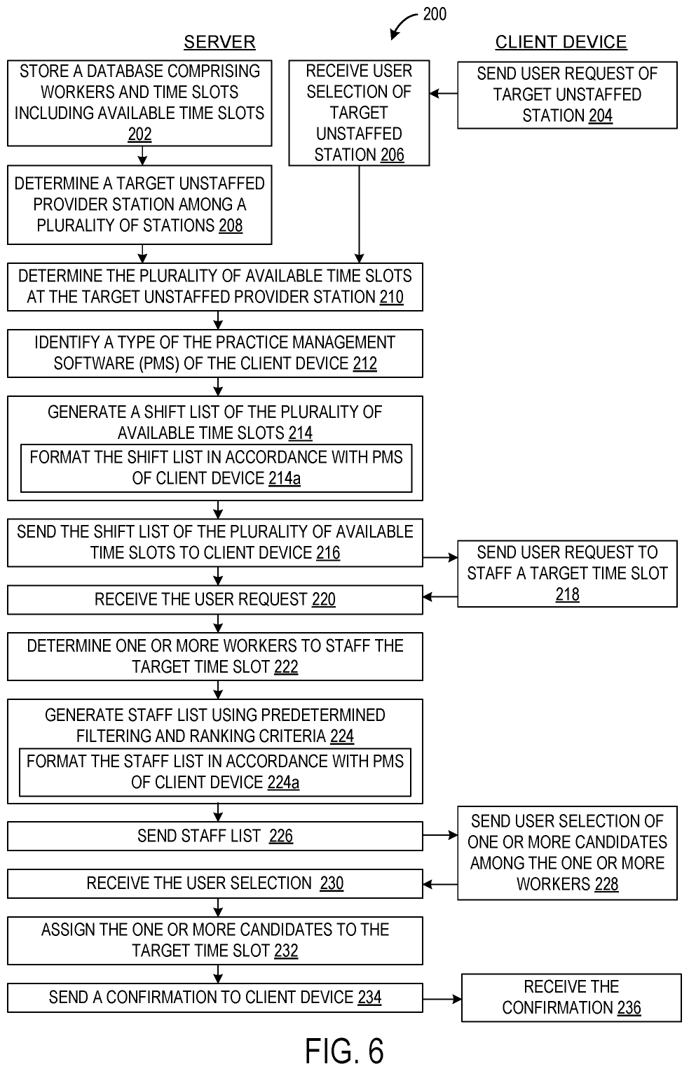

FIG. 6 illustrates a flowchart of a computerized method 200 for staffing automation. The following description of computerized method 200 is provided with reference to the software and hardware components described above and shown in FIGS. 1 to 5. It will be appreciated that computerized method 200 also may be performed in other contexts using other suitable hardware and software components.

The method includes, at step 202, which is performed at the server, storing a database comprising a plurality of workers and a plurality of time slots including a plurality of available time slots. At step 208, also performed at the server, the method includes determining a target unstaffed provider station among a plurality of stations. At step 210, also performed at the server, the method includes determining the plurality of available time slots at the target unstaffed provider station.

At step 204, the method includes sending, from a user of a user client device, a user request of a target unstaffed provider station. At step 206, which may be performed at the server, the method includes receiving the user selection of the target unstaffed provider station. Subsequent to receiving the user selection of the target unstaffed provider station, step 210 may then be performed at the server to determine the plurality of available time slots at the target unstaffed provider station.

At step 212, which may be performed at the server, the method includes identifying a type of the practice management software of the client computing device. Step 214 is performed at the server to generate a shift list of the plurality of available time slots. Step 214 may include step 214a of formatting the shift list in accordance with the practice management software of the client computing device. Alternatively, each of the different types of practice management software may be configured, e.g., through a configuration file, to interface with an application programming interface of the server according to a pre-agreed set of API protocols. At step 216, which may be performed at the server, the method includes sending the shift list of the plurality of available time slots to a practice management software of a client computing device. At step 218, the method may include, sending, from a user of the client computing device, a user request from the practice management software of the client computing device to determine one or more workers of the plurality of workers to staff a target time slot among the plurality of available time slots.

At step 220, which may be performed at the server, the method includes receiving a user request from the practice management software of the client computing device to determine one or more workers of the plurality of workers to staff a target time slot among the plurality of available time slots.

At step 222, which may be performed at the server, the method includes determining the one or more workers of the plurality of workers to staff the target time slot among the plurality of available time slots. At step 224, which may be performed at the server, the method includes generating a staff list of the one or more workers to send to the practice management software of the client computing device using predetermined filtering criteria and predetermined ranking criteria. Step 224 may include step 224a of formatting the staff list in accordance with the practice management software of the client computing device. At step 226, which may be performed at the server, the method includes sending the staff list of the one or more workers to the practice management software of the client computing device. At step 228, the method includes sending, from a user of the client computing device, a user selection of one or more candidates among the one or more workers from the practice management software of the client computing device.

At step 230, which may be performed at the server, the method includes receiving the user selection of one or more candidates among the one or more workers from the practice management software of the client computing device. At step 232, which may be performed at the server, the method includes assigning the one or more candidates to the target time slot. At step 234, which may be performed at the server, the method includes sending a confirmation to the client computing device that the scheduling of the target time slot has been completed. At step 236, the client computing device receives the confirmation.

Additionally, the automated staffing platform may include integrated customer contact software to promote openings on specific days for vacant operatories to the practice's existing customer base, thereby allowing customers to shift future appointments forward. For example, the automated scheduling platform may be used to send notifications to patients who are already scheduled, but are scheduled weeks or months out, offering these patients the opportunity to be scheduled earlier utilizing the shift worker availability.

The above-described system and method are configured to achieve the integration of the automated staffing platform with a practice management system to fill vacant stations with shift workers synchronizes the clientele demand for service with available providers. This provides the businesses with the opportunity to schedule more appointments and schedule appointments sooner, thereby increasing client satisfaction, service efficiency, and profitability of the business.

In some embodiments, the methods and processes described herein may be tied to a computing system of one or more computing devices. In particular, such methods and processes may be implemented as a computer-application program or service, an application-programming interface (API), a library, and/or other computer-program product.

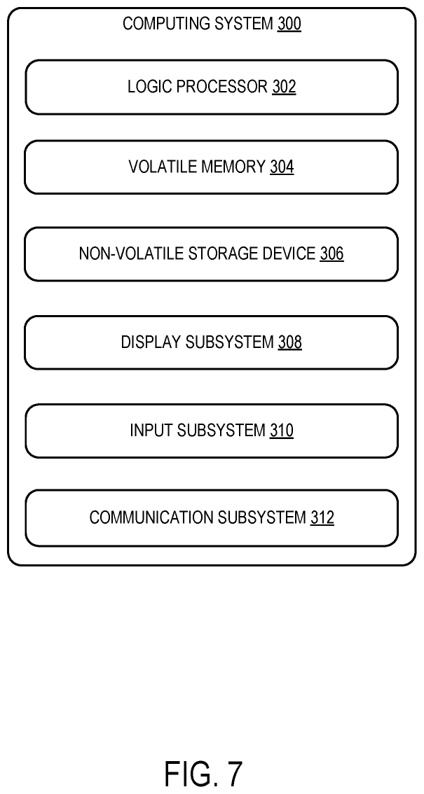

FIG. 7 schematically shows a non-limiting embodiment of a computing system 300 that can enact one or more of the methods and processes described above. Computing system 300 is shown in simplified form. Computing system 300 may embody the computer device 12 and client computing devices 100a, 100b described above and illustrated in FIG. 1. Computing system 300 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components not shown in FIG. 7.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built-in. Non-volatile storage device 306 may include optical memory, semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 300 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for staffing automation, the computing system comprising:
a processor and memory of a computing device, wherein
the memory stores a database comprising a plurality of workers and a plurality of time slots including a plurality of available time slots;
the processor is configured to execute an application programming interface (API) using portions of the memory to:
receive a user request from practice management software of a client computing device to determine one or more workers of the plurality of workers to staff a target time slot among the plurality of available time slots,
send a staff list of the one or more workers to the practice management software of the client computing device, and
receive a user selection of one or more candidates among the one or more workers from the practice management software of the client computing device; and
the processor is further configured to execute a scheduling program using portions of the memory to:
determine the one or more workers of the plurality of workers to staff the target time slot among the plurality of available time slots, and
generate the staff list of the one or more workers to send to the practice management software of the client computing device.

2. The computing system of claim 1, wherein
the processor is configured to execute the scheduling program using portions of the memory to:
determine a target unstaffed provider station among a plurality of provider stations,
determine the plurality of available time slots at the target unstaffed provider station,
generate a shift list of the plurality of available time slots, and
the processor is configured to execute the application programming interface using portions of the memory to:
send the shift list of the plurality of available time slots to the practice management software of the client computing device before receiving the user request.

3. The computing system of claim 2, wherein the target unstaffed provider station is determined based on predetermined criteria comprising at least one selected from the group consisting of: a proportion of vacant appointment time slots at the plurality of provider stations, and a number of customer requests for the target unstaffed provider station.

4. The computing system of claim 2, wherein, to generate the shift list of the plurality of available time slots, the shift list of the plurality of available time slots is formatted in accordance with the practice management software of the client computing device.

5. The computing system of claim 1, wherein
the user request includes a request to staff a target unstaffed provider station on a specified day; and
the processor is configured to execute the scheduling program using portions of the memory to:
determine the plurality of available time slots at the target unstaffed provider station,
generate a shift list of the plurality of available time slots, and
the processor is configured to execute the application programming interface using portions of the memory to:
send the shift list of the plurality of available time slots to the practice management software of the client computing device before receiving the user request.

6. The computing system of claim 1, wherein
to generate the staff list of the one or more workers to send to the practice management software of the client computing device, the staff list of the one or more workers is filtered based on predetermined filtering criteria.

7. The computing system of claim 6, wherein the predetermined filtering criteria comprise at least one selected from the group consisting of: fulfilling a job title requirement, fulfilling a credential requirement, exceeding a predetermined review score threshold, completion of a predetermined threshold number of shifts, and experience exceeding a predetermined length.

8. The computing system of claim 1, wherein each of the plurality of time slots has properties including start and end times, location, predetermined filtering criteria, and predetermined ranking criteria.

9. The computing system of claim 8, wherein, to generate the staff list of the one or more workers to send to the practice management software of the client computing device, the staff list of the one or more workers is ranked based on the predetermined ranking criteria corresponding to the target time slot.

10. The computing system of claim 9, wherein the predetermined ranking criteria comprise at least one selected from the group consisting of: matching a location of the target time slot with locations of the one or more workers, matching an availability of start and end times of the target time slot with availabilities of the one or more workers, and matching job title and credential requirements of the target time slot with job titles and credentials of the one or more workers.

11. The computing system of claim 1, wherein the staff list of the one or more workers is formatted in accordance with the practice management software of the client computing device.

12. A method for staffing automation, the method comprising:
storing a database comprising a plurality of workers and a plurality of time slots including a plurality of available time slots;
receiving a user request from practice management software of a client computing device to determine one or more workers of the plurality of workers to staff a target time slot among the plurality of available time slots;
receiving a user selection of one or more candidates among the one or more workers from the practice management software of the client computing device;
determining the one or more workers of the plurality of workers to staff the target time slot among the plurality of available time slots;
generating a staff list of the one or more workers to send to the practice management software of the client computing device; and
sending the staff list of the one or more workers to the practice management software of the client computing device, wherein
the staff list is formatted in accordance with the practice management software of the client computing device.

13. The method of claim 12, further comprising steps to:
determining a target unstaffed provider station among a plurality of provider stations;
determining the plurality of available time slots at the target unstaffed provider station;
generating a shift list of the plurality of available time slots; and
sending the shift list of the plurality of available time slots to the practice management software of the client computing device before receiving the user request.

14. The method of claim 13, wherein the target unstaffed provider station is determined based on predetermined criteria comprising at least one selected from the group consisting of: a proportion of vacant appointment time slots at the plurality of provider stations, and a number of customer requests for the target unstaffed provider station.

15. The method of claim 13, wherein, to generate the shift list of the plurality of available time slots, the shift list of the plurality of available time slots is formatted in accordance with the practice management software of the client computing device.

16. The method of claim 12, wherein
the user request includes a request to staff a target unstaffed provider station on a specified day; and
the method further comprises:
determining the plurality of available time slots at the target unstaffed provider station,
generating a shift list of the plurality of available time slots, and
sending the shift list of the plurality of available time slots to the practice management software of the client computing device before receiving the user request.

17. The method of claim 12, wherein to generate the staff list of the one or more workers to send to the practice management software of the client computing device, the staff list of the one or more workers is ranked based on predetermined filtering criteria.

18. The method of claim 17, wherein the predetermined filtering criteria comprise at least one selected from the group consisting of: fulfilling a job title requirement, fulfilling a credential requirement, exceeding a predetermined review score threshold, completion of a predetermined threshold number of shifts, and experience exceeding a predetermined length.

19. The method of claim 12, wherein
each of the plurality of time slots has properties including start and end times, location, predetermined filtering criteria, and predetermined ranking criteria;
generating the staff list of the one or more workers to send to the practice management software of the client computing device is accomplished at least in part by ranking the staff list of the one or more workers based on the predetermined ranking criteria corresponding to the target time slot; and
the predetermined ranking criteria comprise at least one selected from the group consisting of: matching a location of the target time slot with locations of the one or more workers, matching an availability of start and end times of the target time slot with availabilities of the one or more workers, and matching job title and credential requirements of the target time slot with job titles and credentials of the one or more workers.

20. A computing system for staffing automation, the computing system comprising:
a processor and memory of a computing device, wherein
the memory stores a database comprising a plurality of workers and a plurality of time slots including a plurality of available time slots;
the processor is configured to execute an application programming interface (API) using portions of the memory to:
receive a user request from practice management software of a client computing device to determine one or more workers of the plurality of workers to staff a target time slot among the plurality of available time slots,
identify a type of the practice management software of the client computing device,
generate a staff list of the one or more workers formatted in accordance with formatting requirements of the type of the practice management software of the client computing device, and
send the staff list of the one or more workers to the practice management software of the client computing device.
